(19) United States
(12) Patent Application Publication
(10) Pub. No.: US 2006/0237996 A1
(43) Pub. Date: Oct. 26, 2006

(54) Motor vehicle body comprising a support structure made of large-size partial modules

(76) Inventors: Konrad Eipper, Rottenburg (DE); Wofgang Fussnegger, Tuebingen (DE); Christian Mayer, Renningen (DE); Bernhard Spies, Sindelfingen (DE); Carlos Valdivieso, Tiefenbronn (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/525,719

(22) PCT Filed: Aug. 8, 2003
(86) PCT No.: PCT/EP03/08815

§ 371 Date: Oct. 11, 2005

(30) Foreign Application Priority Data
Aug. 27, 2002 (DE) 102 39 990.5

(51) Int. Cl. B60J 7/00

(52) U.S. Cl. 296/193.04

(57) ABSTRACT

A motor vehicle body includes a support structure made of large-sized partial modules. A roof module has front and rear roof columns placed onto a basic module approximately level with a side wall edge of the body, and the front and rear roof columns of the roof module are connected to one another via a respectively assigned cross member. In order to provide a support structure having a basic module for different roof structures, and to make the support structure very stiff with the roof module, the rear roof columns are connected to each other via a supporting plate of a rear parcel shelf which is stiffened by the assigned cross member.

### BACKGROUND AND SUMMARY OF THE INVENTION

This invention relates to a motor vehicle body.

A motor vehicle body described in German document DE 37 20 344 A1 comprises a support structure made of large-size partial modules. A roof module of the support structure is placed via front and rear roof columns onto a basic module level with the side wall edge, and the front and rear roof columns are connected to one another via a respectively assigned cross member. In this case, the rear roof columns are connected to one another via a rear parcel shelf which is stiffened by the assigned cross member.

A body which comprises a support structure made of large-size partial modules is already known from European document EP 0 250 678 B1. One of the partial modules is a roof module which is placed with front and rear roof columns onto a basic module approximately level with the side wall edge of the body. In this case, the front and rear roof columns are connected to one another via a respectively assigned cross member in order to stiffen the roof module.

An object of the invention is the provision of a body comprising a support structure which is embodied in a very stiff manner in the region in which chassis forces are introduced by the rear axle.

This object is achieved according to the invention.

Advantageous refinements of the invention are apparent from the claims.

In the case of the support structure of the body according to the invention, the rear roof columns are connected to one another via a supporting plate of a rear parcel shelf, as a result of which, first of all, an improved stiffening of the rear roof columns of the roof module or of the entire assembled support structure arises. In this case, the at least one cross member is integrated into the supporting plate, as a result of which an overall extremely stiff bond is created at the rear end of the roof module. The arrangement of the supporting plate on the roof module makes it possible, with the basic module structure arranged below it, to omit transversely stiffening elements at the upper end thereof. In other words, those wall regions of the rear side walls of the basic module which adjoin the rear roof columns do not need to be connected at their upper ends—for example via a cross member—with the result that a clearance is provided between said wall regions. As a result, the basic module is suitable, for example, for use for an open motor vehicle, in which the clearance between said wall regions is required for a folding top compartment.

In the support structure of the body according to the invention, the rear roof columns are connected to one another via a supporting plate of a rear parcel shelf, as a result of which, first of all, an improved stiffening of the rear roof columns of the roof module or of the entire assembled support structure arises. In this case, the at least one cross member is integrated into the supporting plate, as a result of which an overall extremely stiff bond is created at the rear end of the roof module. The arrangement of the supporting plate on the roof module makes it possible, with the basic module structure arranged below it, to omit transversely stiffening elements at the upper end thereof. In other words, those wall regions of the rear side walls of the basic module which adjoin the rear roof columns do not need to be connected at their upper ends—for example via a cross member—with the result that a clearance is provided between the wall regions. As a result, the basic module is suitable, for example, for use for an open motor vehicle, in which the clearance between the wall regions is required for a folding top compartment.

The support arrangement, which extends in the transverse direction of the vehicle and is closed by the supporting plate of the roof module to form a supporting frame, makes it possible for the rear region of the support structure, into which chassis forces are introduced by the rear axle, to be embodied in a very stiff manner. In this case, the chassis forces can be introduced particularly readily into the supporting frame or the support structure, since supports are provided which run in the vertical direction of the vehicle, are connected to one another via a cross member level with a vehicle floor, and are arranged on the inside of rear wheel houses.

Further advantages, features and details of the invention are apparent from the description below of a preferred embodiment and with reference to the drawings.

### BRIEF DESCRIPTION OF THE DRAWINGS

FIG. 1 shows a perspective exploded illustration of the support structure of the motor vehicle body according to the invention, which support structure is made of large-size partial modules;

FIG. 2 shows a further perspective exploded illustration of the support structure which is made of partial modules and is lined with outer panel parts;

FIG. 3 shows a perspective view of the roof module of the support structure; and

FIG. 4 shows a perspective view of the basic module of the support structure.

### DETAILED DESCRIPTION OF THE INVENTION

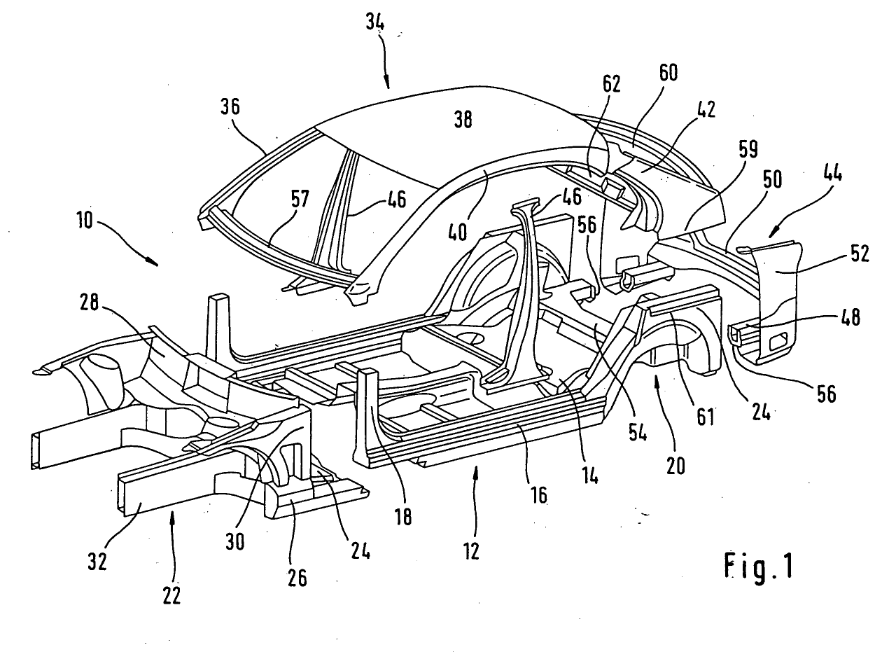

FIG. 1 shows, in a perspective exploded illustration, a support structure 10 of a motor vehicle body which is assembled from a plurality of large-size partial modules which are described in more detail below. In the exemplary embodiment shown here, the partial modules of the support structure 10 are produced in each case from a plurality of sheet-metal parts which are joined together; at the same time, however, the partial modules may also be premanufactured in different constructions, for example as a “space frame”, as plastic parts, metal cast parts, as components in a “sandwich construction” or the like. In particular, combinations of different constructions for the partial modules which are fitted together are also conceivable, depending on the application and loading. The individual modules are joined together in particular via bonding connections, welding connections or the like. At the same time, other customary connections, such as screw connections or the like, are conceivable.

A basic module 12 of the support structure 10 essentially comprises a body floor 14 which is bounded laterally by longitudinal members 16. The basic module 12 reaches forward as far as column sections 18 of front wall columns which protrude upward from the respectively associated front ends of the lateral longitudinal members 16. The body floor 14 of the basic module 12 ends at a considerable distance behind the front end of the basic module 12 or behind the column sections 18 of the front wall columns. At the rear, the basic module 12 ends behind rear wheel houses 20, above which wall regions 24 of the particular rear side wall are arranged. The basic module 12 is already equipped as far as possible with the other partial modules before it is fitted together.

A front end module 22 which comprises a front end region 24 of the body floor 14 and extends between lateral longitudinal member sections 26 of the front end module 22 is connected to the basic module 12. The front end region 24 of the body floor 14 ends forward at a front end wall 28 which extends to approximately level with the side wall edge and is bounded laterally by column sections 30 of the front wall columns. At the front ends of the front end module 22, front longitudinal members 32 can be seen.

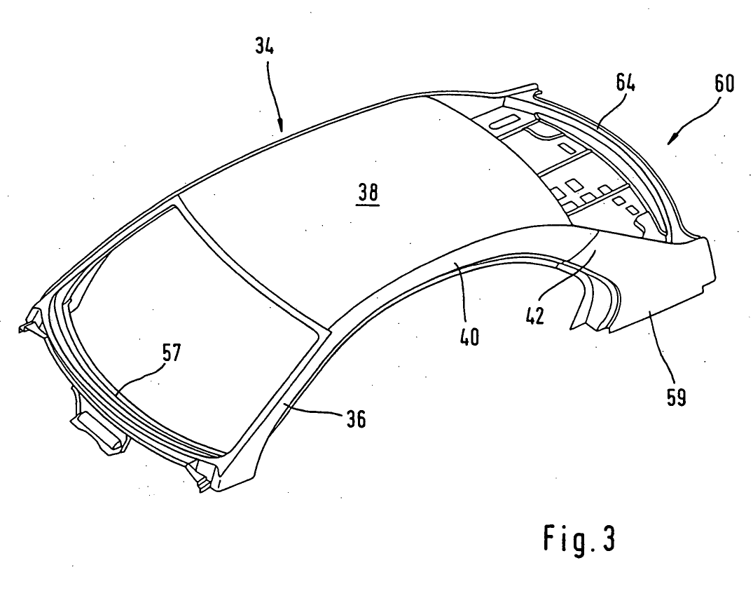

A roof module 34, which can be seen in overall view in FIG. 3, can be placed onto the basic module 12 and the front end module 22 and here comprises lateral A-columns 36, lateral roof struts 40 in the region of the roof 38, and C-columns 42. When the support structure 10 is assembled, the A-columns 36 are supported on the basic module 12 and on the front end module 22.

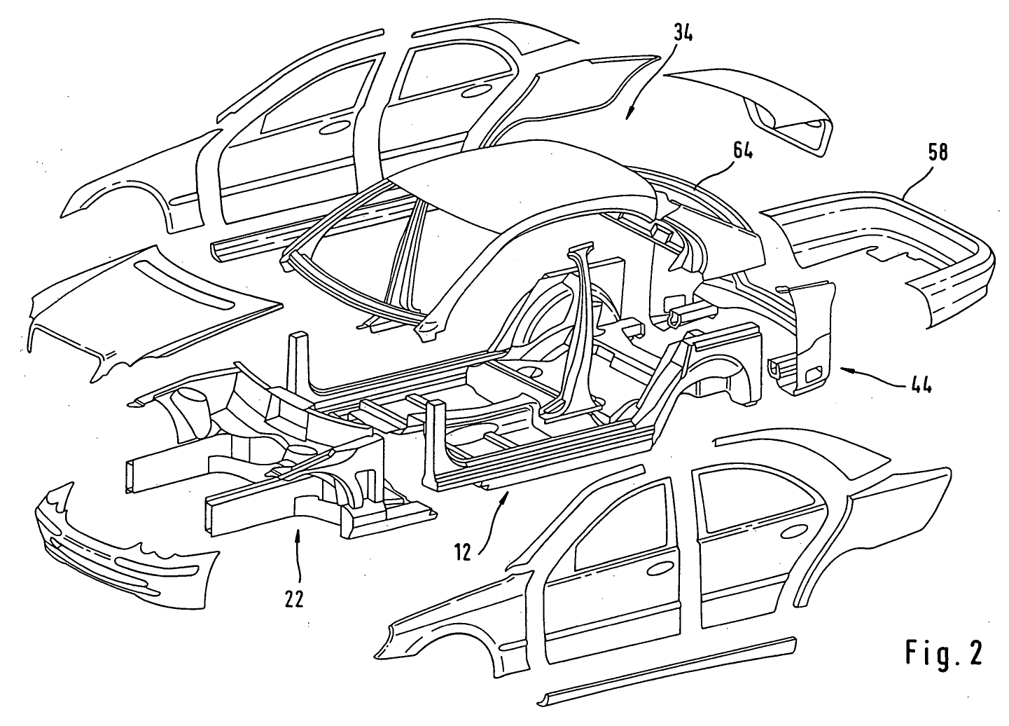

At the rear, the basic module 12 is adjoined by a rear module 44 which, when the support structure 10 is assembled together with the rear end region of the basic module 12, belongs to the rear crumple zone of the motor vehicle and bounds a trunk to the rear. The rear module 44 essentially comprises lateral, rear longitudinal member sections 48, a rear cross member 50 connecting the longitudinal member sections 48, and rear side wall regions 52. By means of a cross member 54 (explained below) and the longitudinal members 16 of the basic module 12 and by means of the longitudinal member sections 48 and the rear cross member 50 of the rear module 44, when the support structure is assembled a frame surrounding a spare wheel trough (not shown) is formed. It is apparent that the rear module 44 is connected to the basic module 12 and the roof module 34 along a transverse plane of the vehicle running vertically in each case. The rear module 44 is fastened to the basic module 12 and to the roof module 34 via flanges 56 on the longitudinal members 16 and on the associated longitudinal member sections 48, and also via further joining points (not shown) between the modules 12, 34 and 44. To the rear, the rear module 44 is adjoined by a rear end module with a bumper 58 which can be seen in FIG. 2.

A B-column 46 extends in each case between that roof strut 40 of the roof module 34 which laterally bounds the roof 38 and the lateral longitudinal member 16 of the basic module 12, which B-column is designed as a separate component and is to be fixed on the roof strut 40 or on the lateral longitudinal member 16 during assembly of the partial modules 12, 22, 34, 44.

FIG. 2 illustrates, in a further perspective exploded illustration, the support structure 10 which is assembled from the partial modules 12, 22, 34, 44 and, in the region of the front and rear wings and of the sill, is lined with outer panel parts of plastic, sheet metal or the like.

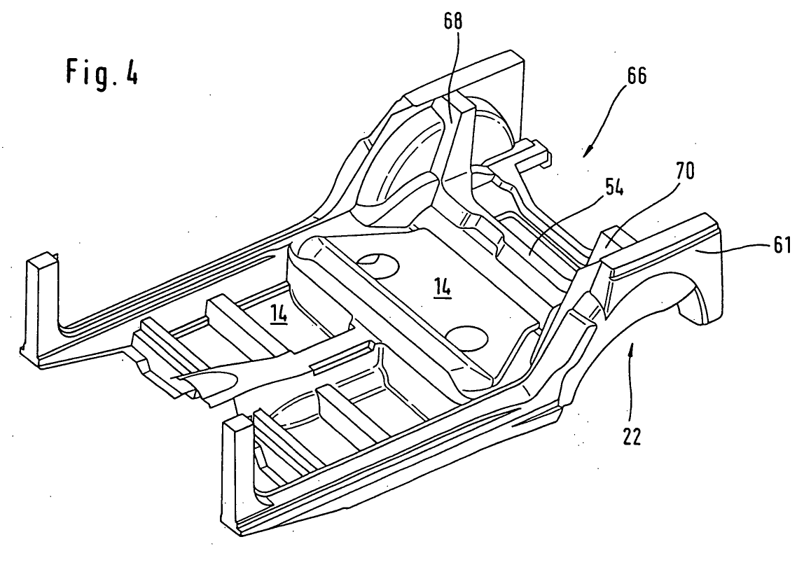

In an overall view of FIG. 1 together with FIGS. 3 and 4, which respectively show the roof module 34 and the basic module 12 in a perspective view, it is apparent that the lower ends 59 of the C-pillars 42 are supported on the respectively associated, upper end 61 of the wall regions 24, with the modules 12, 34 being connected to each other along joining surfaces, for example by means of a bonding connection. The joining surfaces and therefore the division of the two modules 12, 34 run approximately level with the side wall edge of the body. It is apparent that the lower ends 59 of the C-columns 42 already form an upper section of the rear side wall 24.

The A-pillars 36 of the roof module 34 are connected to each other via a cross member 57 which bounds the end wall 28 upward. The rear roof columns 42, which are designed here as C-columns 42, are connected to each other via a supporting plate 60 of a rear parcel shelf which runs here at least approximately in the horizontal direction. The supporting plate 60 is bounded to the front and rear by front and rear cross members 62, 64 and is stiffened by them. In this case, the supporting plate 60 at the lower ends 59 of the C-pillars 42 of the roof module 34 runs approximately level with the side wall edge, with the lower ends 59 of the C-columns 42 already having to be assigned to the side wall sections 24. It is also apparent in FIG. 3 that the roof module 34 ends directly behind the supporting plate 60 along the vertical separating plane at which the rear module 44 adjoins the roof module 12. A rear separating wall, which is bounded on the upper side by the cross member 62, can be arranged on the front cross member 62 (FIG. 1). The rear cross member 64 is designed as the lower boundary for accommodating the rear window.

It is apparent from FIG. 4 that the basic module 12 has a support arrangement 66 which extends in the transverse direction of the vehicle and has the cross member 54 running level with the vehicle floor 14 and two supports 68, 70 arranged on the inside of the rear wheel houses 20 in the vertical direction of the vehicle. By means of the supporting plate 60 of the roof module 34, this support arrangement 66 is closed to form a very stiff supporting frame, so that chassis forces introduced by the rear axle can be very readily absorbed by the supporting frame. In the exemplary embodiment shown here, the front cross member 62 of the supporting plate 60 is arranged precisely in the direction of extent with the supports 68, 70 running in the vertical direction of the vehicle, and is connected directly to them.

1-8. (canceled)

9. A motor vehicle body having a support structure made of large-size partial modules comprising:
a roof module having front and rear roof columns,
a basic module onto which the roof module is placed which is approximately level with a side wall edge of the body,
respectively assigned cross members via which the front and rear roof columns of the roof module are connected to one another, and
a supporting plate of a rear parcel shelf which is stiffened by at least one of the cross members via which the rear roof columns are connected to one another,
wherein the basic module comprises a support arrangement which extends in a transverse direction of the vehicle and is closed by the supporting plate to form a supporting frame, and
wherein the support arrangement has supports which run in a vertical direction of the vehicle and are connected to each other via a further cross member extending level with a vehicle floor.

10. The body as claimed in claim 9, wherein the supporting plate is bounded at front and rear ends by a respective one of the cross members.

11. The body as claimed in claim 9, wherein the supports of the support arrangement are arranged on insides of rear wheel houses.

12. The body as claimed in claim 9, wherein the supports of the support arrangement are connected directly to a front cross member of the supporting plate.

13. The body as claimed in claim 9, wherein the supporting plate is arranged at lower ends of the rear roof columns between upper side wall sections of the roof module.

14. The body as claimed in claim 9, wherein the roof module ends along a vertical separating plane directly behind the supporting plate, and wherein a rear module adjoins the roof module.
